(19) United States
(12) Patent Application Publication
(10) Pub. No.: US 2021/0261161 A1
(43) Pub. Date: Aug. 26, 2021

(54) Safety System For An Electrically Drivable Motor Vehicle, Method For Operating Such A Safety System And Motor Vehicle

(71) Applicant: Volkswagen Aktiengesellschaft, Wolfsburg (DE)

(72) Inventor: Hauke Christian Schlimme, Braunschweig (DE)

(73) Assignee: Volkswagen Aktiengesellschaft, Wolfsburg (DE)

(21) Appl. No.: 17/181,872

(22) Filed: Feb. 22, 2021

(30) Foreign Application Priority Data
Feb. 26, 2020 (DE) 10 2020 202 477.4

(51) Int. Cl. B60W 60/00; B60W 10/20; B60W 10/18; B60W 30/08

(52) U.S. Cl. CPC B60W 60/0016; B60W 30/08; B60W 10/18; B60W 10/20

(57) ABSTRACT

The invention relates to a safety system for an electrically drivable motor vehicle, with a first brake system and with a second brake system which comprises at least one electric machine designed for driving the motor vehicle, and with a third brake system, wherein the safety system is switchable from a normal operation mode, in which the motor vehicle can be braked by means of the first brake system, into a failure operation mode, in which the motor vehicle can be braked by means of the second brake system. The failure operation mode comprises a failure mode A, in which the motor vehicle can be braked by means of the third brake system, and a failure mode B, in which the motor vehicle can be braked by means of the second brake system.

### CROSS-REFERENCE TO RELATED APPLICATIONS

This application claims priority to German Patent Application No. DE 10 2020 202 477.4, filed on Feb. 26, 2020 with the German Patent and Trademark Office. The contents of the aforesaid patent application are incorporated herein for all purposes.

### TECHNICAL FIELD

The invention relates to a safety system for an electrically drivable motor vehicle, to a method for operating such a safety system, and to a motor vehicle equipped with such a safety system.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

Nowadays there are far-reaching efforts in motor vehicle technology to more and more automate motor vehicles, in particular passenger vehicles, in order to relieve a driver of the motor vehicle or passenger vehicle from driving tasks. According to SAE J3016, the respective degrees of automation or rather degrees of autonomy are divided into five levels. In particular in connection with levels 3, 4 and 5, in which the driver of the motor vehicle may at least temporarily turn away from a current driving task and/or from the traffic situation, there is of course the need to provide motor vehicles that are automated in accordance with levels 3, 4 and/or 5 in particularly safe manner.

In the case of highly automated motor vehicles (level 3), for example, the driver is able to turn away from the driving tasks at least temporarily and/or in certain specified or specific applications of the motor vehicle. This means that the motor vehicle drives independently or rather fulfills the driving tasks independently. The motor vehicle, which is highly automated in accordance with level 3, is in particular designed to control a braking system of the motor vehicle independently or rather automatically, that is to say without an action of the driver, in order to brake the motor vehicle in motion as required. For this purpose, this brake system comprises a control unit, for example an ESP or ESC unit (ESP: electronic stability program; ESC: Electronic Stability Control). By means of this control unit a brake actuator of the brake system can be controlled electrically and/or hydraulically in order to be able to decelerate the motor vehicle, for example on the basis of the principle of a friction brake. If the braking system fails in whole or in part, it must be taken into account that the driver may not attend to the driving task or rather to the traffic situation, which would prevent the vehicle from being bakeable during this period. Therefore, today's motor vehicles that are highly automated according to Level 3 do comprise a fallback level, i.e. a second brake system, by means of which the motor vehicle can be safely braked to a standstill if the brake system has completely or partially failed. This second brake system may be operated either manually by the driver or automatically, depending on the availability of the driver.

In a fully automated motor vehicle (level 4), the driver is able to completely leave the handling of the driving tasks to the motor vehicle, at least temporarily, for example over the entire duration of a specific application—the driver is then only a passenger of the motor vehicle. In the case of autonomous vehicles (level 5), no human driver is provided at all. This means that only passengers are transported by means of the motor vehicle, which is autonomous according to level 5, whereby these passengers do not control or supervise/monitor any driving task of the motor vehicle at any time. Since, in fully automated (Level 4) and autonomous (Level 5) vehicles, the driver or rather the passenger is allowed to turn away from traffic or driving tasks at least temporarily, i.e., in a specific application, there is no possibility of manual actuation of the second brake system—as described in connection with the highly automated (Level 3) motor vehicle. This means that a fallback level for fully automated or rather autonomous motor vehicles must also be fully automated or rather autonomous, and therefore must be able to safely brake the motor vehicle to a standstill without any action of the passenger.

However, there is likewise a need, particularly in the case of fully automated or autonomous motor vehicles, to enable continued travel despite the first brake system having completely or partially failed, for example to be able to drive to a repair facility by means of the motor vehicle. It can then be assumed that another fault may occur during driving on, in which case the brake system of the first fallback level fails in full and/or in part. In order to be able to ensure safe stopping or braking of the fully automated or autonomous motor vehicle, a further, for example third braking system is provided, by means of which the fully automated/autonomous motor vehicle according to level 4/5 can be safely braked to a standstill.

### SUMMARY

An object exists to provide a safety system, a method, and a motor vehicle by means of which safety in road traffic is increased.

The object is solved by a safety system, a method for operating the safety system as well as a motor vehicle equipped with such a safety system according to the independent claims. Embodiments of the invention are discussed in the dependent claims and the following description.

### BRIEF DESCRIPTION OF THE DRAWINGS

FIG. 1 shows a schematic view of an exemplary motor vehicle which is designed to be drivable in a highly automated manner and comprises a safety system; and

FIG. 2 shows a schematic view of an exemplary motor vehicle, which can be driven fully automatically and/or can be driven autonomously and comprises the safety system.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Embodiments of, safety systems for an electrically drivable motor vehicle are provided, which in particular may be highly automated (level 3), fully automated (level 4) and/or autonomous (level 5). For example, the motor vehicle may be a passenger vehicle.

According to a first exemplary aspect, a safety system is provided that comprises a first brake system which may be used, for example, as an operational brake system in the motor vehicle. Furthermore, the safety system of this aspect comprises a second brake system which is at least partially designed differently from the first brake system or rather is at least partially designed separately from the first brake system. The second brake system comprises at least one electric machine which is designed to drive the electrically drivable motor vehicle. In other words, the electric machine of the second brake system is usable or used in the electrically drivable motor vehicle in order to drive or move the motor vehicle in a motorized operation. Furthermore, the electric machine in the motor vehicle may be used in a generator mode to brake the motor vehicle. Furthermore, the safety system comprises a third brake system, which is also at least partially different from the first brake system and the second brake system. This means that the third brake system is at least partially separate from the first brake system and from the second brake system.

The safety system in some embodiments may be switched from a normal operation mode into a failure operation mode. If the safety system is switched to the normal operation mode or if the safety system is operated on the basis of the normal operation mode, the motor vehicle may be braked by means of the first brake system. In other words, a first braking force may be generated during the normal operation mode by the safety system, for example by the first brake system, by means of which the motor vehicle may be braked. In the failure operation mode, a second braking force may be generated by the safety system, for example by the second brake system, by means of which the motor vehicle may be braked. This means that in the failure operation mode of the safety system the motor vehicle may be braked by means of the second brake system.

Herein, the normal operation mode is to be understood as meaning that the safety system functions as intended, for example within normal operating parameters, wherein the safety system does not have any failure, for example damage. In this regard, the failure operation mode is to be understood as meaning that the safety system, for example the first brake system, only has a reduced performance compared to normal operation of the safety system. This is the case, for example, when the motor vehicle may only be braked insufficiently or not at all by means of the first brake system, for example due to a damage to the same.

In order to design the safety system in such a way that it increases safety in road traffic, according to the present exemplary aspect, the failure operation mode has a failure mode A and a failure mode B configured differently therefrom. In the failure mode A, the motor vehicle may be braked by means of the third brake system. In the failure mode B, the motor vehicle may be braked by means of the second brake system. Accordingly, the safety system may be switched to the failure mode A, for example by switching the safety system from its normal operation mode to the failure operation mode. In other words, it may be provided that the failure operation mode is configured as failure mode A. Furthermore, it may be provided that the safety system may be switched to the failure mode B, for example by switching from its normal operation mode to the failure operation mode.

In some embodiments, the safety system may be switched or switched over from its normal operation mode to the failure operation mode if the first brake system has completely or partially failed, so that the motor vehicle may no longer be braked or may only be braked using the reduced performance of the first brake system. In the failure mode A of the failure operation mode, a third braking force may then be generated by means of the third brake system, which when braking the vehicle supports the first braking force—reduced due to the failure operation—or replaces it—if the first brake system has completely failed. This applies analogously to the failure mode B of the failure operation mode, wherein the safety system may be switched from its normal operation mode to the failure mode B, for example, if the first brake system only provides the reduced performance compared to normal operation. In the failure mode B, the motor vehicle may therefore be braked by means of the second brake system, in which the latter generates a second braking force with the aid of which the motor vehicle may be braked.

In this manner, a redundant safety system is provided, enabling the motor vehicle to be braked to a standstill in a particularly safe manner in road traffic—even if the first and/or the third brake system have/has failed in full or in part. Alternatively, driving on of the motor vehicle is possible, although the first and/or the third brake system have/has completely or partially failed. As a result, the safety system is particularly conducive to road traffic safety, since the safety system provides two fallback levels, so that the motor vehicle may be driven out of the traffic situation in a particular efficient manner. Therefore, other road users are not or only to a very small extent impaired by a motor vehicle equipped with such a safety system.

In some embodiments, the safety system may first be switched from the normal operation mode to the failure mode A and may be switched from the failure mode A to the failure mode B. In this context, the first brake system assigned to the normal operation mode, for example the operational brake system, comprises a first performance capability. Accordingly, it is provided that the third brake system assigned to the failure operation mode A comprises a third performance capability which at least substantially corresponds to the first performance capability or is less than the first performance capability of the first brake system. The second brake system assigned to the failure mode B may accordingly have a second performance capacity that is less than the third performance capacity of the third brake system.

As an alternative or in addition and in some embodiments, it may be provided that the safety system may be switched from the normal operation mode first to the failure mode B and then from there to the failure mode A. The safety system may be designed to be particularly efficient in terms of mass and/or space, since usually a particularly high performance capability of the brake system comes along with a particularly high space requirement and a particularly large mass of the corresponding brake system. In other words, it may be provided that the third brake system is lighter than the first brake system and that the second brake system is lighter than the third brake system. As a result, a motor vehicle electrically drivable by the safety system may be operated with particularly low emissions and/or fuel efficient or energy efficient.

In some embodiments, the safety system is designed to be even more efficient in terms of mass and space as well as being particularly simple or inexpensive. In the present embodiments, the third brake system comprises a third brake actuator which is formed by a first brake actuator of the first brake system. This means that the first brake system comprises the first brake actuator. The first brake actuator then generates the first braking force in the normal operation mode. The first brake actuator is also included into the third brake system, which means that the first brake actuator forms the third brake actuator. As a result, the third brake actuator formed by the first brake actuator may generate the third braking force in the failure operation mode of the safety system, in particular in the failure mode A, with the aid of which the motor vehicle may be braked.

In order to further increase the road safety of the safety system or of a motor vehicle equipped with the safety system and in some embodiments, a fourth brake system may be provided by means of which the motor vehicle may be braked in the failure operation mode of the safety system and which is at least partially formed by an electric parking brake system. This means that the parking brake system is designed to be used or installed in the motor vehicle. The fourth brake system of the safety system may, for example, form a further fallback level of the safety system. Alternatively or additionally and in some embodiments, the second brake system and/or the third brake system may be supported by means of the fourth brake system or rather by means of the electric parking brake system. The parking brake system for the motor vehicle usually acts on one of two axles of the motor vehicle or passenger vehicle. If, for example, in the failure operation mode of the safety system, the second brake system and the fourth brake system act on a common one of, for example, two axles of the motor vehicle, it may be provided, for example, that the corresponding axle of the motor vehicle is only braked so strongly that the wheels do not block on the corresponding axle. In other words, it may be provided that a basic braking moment is applied to the wheels of the corresponding axle of the motor vehicle by means of the second brake system. In order to use the maximum transferable braking force between the wheels of the corresponding axle of the vehicle and a surface on which the wheels of the vehicle roll as efficiently as possible and in some embodiments, a further braking moment may be applied to the wheels of the axle by means of the fourth brake system or rather the electric parking brake system wherein the additional braking moment and the basic braking moment are added. For example, the further braking moment is selected so that the corresponding wheels on the axle of the motor vehicle are braked particularly close to the locking limit, but locking of the wheels is still avoided. For this purpose it may furthermore be provided in some embodiments that the safety system comprises a control device by means of which such a control, that is to say an anti-lock control, may be carried out. For example, the further braking moment is smaller than the basic braking moment. The further braking moment is provided for a fine adjustment of a total braking moment, which is applied to the wheels of the corresponding axle, roughly adjusted on the basis of the basic braking moment.

Alternatively and in some embodiments, the possibility of generating the basic braking moment by means of the fourth brake system or rather the parking brake system exists, the further braking moment then being generated by means of the second brake system or the electric machine. This prevents the wheels from locking as a result of a sluggish response behavior of the parking brake system, for example through rapid moment reduction of the electric machine or through driving the electric machine.

If the motor vehicle—as already discussed—comprises two axles, i.e., a first axle and a second axle (for example a front axle and a rear axle spaced therefrom), it is beneficial for a stable driving condition of the motor vehicle that, in particular, the vehicle's wheels of the rear axle when viewed in the direction of travel (“rear axle”) do not block. This is because, for a stable driving condition, it should be provided that the wheels on the rear axle of the vehicle roll and do not block, for example due to the vehicle braking. This is where the fourth brake system or the electric parking brake system intervenes in conjunction with the control device of the safety system, especially in the failure operation mode, wherein the conflict between an intended braking deceleration that is as strong as possible and the requirement that the wheels of the rear axle roll when braking is taken into account. Alternatively or additionally and in some embodiments it may be provided that the fourth brake system or rather the parking brake system is arranged on the first axle (“front axle”) and acts on the front wheels of the motor vehicle.

In some embodiments, the fourth brake system has at least two fourth brake actuators which may be controlled independently from one another. The fourth brake system, designed as an electric parking brake system, usually acts on two wheels on a common axle of the motor vehicle, for example the rear axle of the motor vehicle, which are spaced apart from one another over a track width. Accordingly, the two fourth brake actuators may be controlled, for example, in such a way that a left wheel and a right wheel of the rear axle of the motor vehicle are braked equally strong by means of the fourth brake system or rather the two fourth brake actuators. However, it is possible in some embodiments that the fourth brake actuator on one side, for example the left fourth brake actuator, and the brake actuator on the second side of the motor vehicle, for example the right fourth brake actuator, may be controlled separately from one another, so that, for example, the left wheel of the rear axle of the motor vehicle by means of the fourth brake system is or may be braked more strongly than the right wheel of the rear axle of the motor vehicle.

If, as already described, the basic braking moment is applied to the wheels of the rear axle of the motor vehicle by means of the second brake system, for example, it is possible to add the additional braking moment for each fourth brake actuator separately to the left wheel or the right wheel in some embodiments. This is of particular benefit since an area of the ground directly contacted by the left wheel of the motor vehicle and another area of the ground directly contacted by the right wheel of the motor vehicle may differ in terms of the respective friction properties. For the braked motor vehicle this means that, for example, the left wheel may already block while the right wheel is still rolling, although the left wheel and the right wheel are subject to an equally strong braking moment.

Instead, by means of the safety system the basic braking moment in some embodiments may be applied to the left and right wheel of the motor vehicle, for example by means of the second brake system, the basic braking torque being selected so that neither the left wheel nor the right wheel block on their respective ground. However, this means that one of the two wheels is not braked as well as possible, so that the vehicle is not subject to the desired maximum braking deceleration. Therefore, the further braking moment may be applied to precisely that wheel that is rolling over the ground well below its blocking limit. On the other hand—with regard to the corresponding surface—the other wheel is already braked as best as possible. This means that the best possible braked wheel would undesirably block if a further braking moment were applied to this wheel. Since the two fourth brake actuators may be controlled separately from one another, the further braking moment may be applied to the wheel still rolling over the ground below its blocking limit by means of the fourth brake system or by means of the electric parking brake system, such that the two wheels do not lock when the vehicle is braked. although they roll on the different areas of the ground, which provide the left wheel with a different coefficient of friction than the right wheel.

As already discussed above, it may be provided in some embodiments that the performance of the third brake system is less than the performance of the first brake system. Furthermore, it may be provided that the performance of the second brake system is less than the performance of the third brake system. In view of this, the safety system is even more roadworthy if it is provided that the respective performance of the corresponding braking system is sufficient to brake the motor vehicle as intended. However, it may be that a drive unit of the motor vehicle has a capacity to put the motor vehicle into a driving state, the physical characteristics of which (for example speed, longitudinal and lateral acceleration, etc.) are dimensioned in such a way that the motor vehicle in that driving state cannot be braked reliably, that is to say safe for road traffic, as intended by means of the third brake system and/or by means of the second brake system and/or by means of the fourth brake system. In other words, the performance capability of the drive unit may exceed the performance capability of the corresponding brake system. In order to prevent this and in some embodiments, the safety system may have a control device which may be connected to a drive unit of the motor vehicle and by means of which, at least in the failure operation mode of the safety system, a performance capability of the drive unit may be determined based on a performance capability of one of the brake systems. In this context, it may further be provided that the performance capability of the drive unit may be determined based on prevailing environmental conditions of the surroundings of the motor vehicle. Here, the drive unit of the motor vehicle comprises means for influencing a longitudinal acceleration of the motor vehicle and at least means for influencing a transverse acceleration of the motor vehicle. In other words, the drive unit of the motor vehicle is designed to accelerate, brake and steer the motor vehicle.

If the safety system is in the failure operation mode, for example in failure mode A, it is provided in some embodiments that a data set characterizing the failure mode A is provided, for example transmitted, by means of the control device of the drive unit of the motor vehicle. The performance of the drive unit may then be throttled using the data set. This means, for example, that the drive unit no longer provides a maximum possible acceleration potential, a maximum possible speed potential, a maximum possible steering angle, etc., even if the driver or a control device that may provide the highly automated, fully automated or autonomous functions wishes to call up this potential.

On the one hand and in some embodiments, it is conceivable that, by means of the safety system operated in failure mode A, the performance capability or rather the performance of the drive unit may be adapted or correspondingly throttled to the brake system used in failure mode A, that is to say to the third brake system. It is further provided that, by means of the safety system operated in failure mode B, the performance capability or rather the performance of the drive unit may be adapted or correspondingly throttled to the brake system used in failure mode B, i.e., to the second brake system. In some embodiments, it is provided that after a complete or partial failure of the first brake system, the performance capability of the drive unit is not matched to the brake system of the first fallback level, but to the brake system of the second fallback level. For example, by means of the safety system operated in failure mode A, the performance capability or rather the performance of the drive unit may be adapted to the brake system assigned to failure mode B. Because at least in the case of the fully automated or autonomous motor vehicle according to Level 4 or Level 5, the failure mode A forms the first fallback level and the failure mode B forms the second fallback level in relation to normal operation.

A so-called degraded continuation of the journey is therefore provided, although the safety system has been switched to failure operation mode, for example failure mode A or failure mode B. In this case, the brake systems, for example each of the brake systems taken individually, are designed to safely brake the motor vehicle—at least from the degraded continuation of the journey or rather in the corresponding failure mode A, B—to a standstill.

If the motor vehicle enters an unstable driving state, for example skidding, it is possible in some embodiments to end this unstable driving state particularly quickly, for example by means of counter-steering. If the unstable driving state is generated, for example, due to (over) braking of the vehicle by means of the first (normal mode), the third (failure mode A) and/or by means of the second braking system (failure mode B), the safety system in some embodiments comprises means to counteract or end the unstable driving state. Accordingly, in some embodiments of the safety system, it is provided that it comprises a steering device by means of which braking of the motor vehicle may be assisted in the failure operation of the safety system.

Another exemplary aspect relates to a method for operating a safety system for an electrically drivable motor vehicle. The method has the following steps—not necessarily in the order given:

In one step of the method, the safety system is operated in a normal operation mode. This means that in the normal operation mode the safety system is not subject to any errors. For example, the safety system is undamaged and functions as intended.

In a further step of the method, the motor vehicle is braked, e.g., as required, by means of a first brake system of the safety system. A corresponding braking request may be provided, for example, by a human driver, for example by the human driver pressing a pedal of the service brake system. Alternatively or additionally, the braking request may be provided by a highly automated, fully automated and/or autonomous function of the motor vehicle, for example provided wirelessly and/or wired to the first brake system, for example sent.

For example, if the safety system may no longer be operated in the normal operation mode, for example if the safety system, in particular the first brake system, only has a reduced performance capability compared to the normal operation mode, the safety system is switched from the normal operation mode to a failure operation mode in a further step of the method. If the braking request is now provided to the safety system, the vehicle is braked by means of a second brake system—in a still further step of the method—wherein the vehicle is braked by means of an electric machine by means of which the vehicle may be driven. This means that the electric machine comprises a double functionality, provided that the motor vehicle is equipped with the safety system. Because on the one hand, the electric machine, by being operated in motor mode, serves to drive or move the motor vehicle and, on the other hand, the electric machine, by being operated in a generator mode, is used to brake the motor vehicle.

In order to further increase in road traffic safety by means of the method for operating the safety system, according to the present aspect the method comprises at least two further steps—not necessarily in this order:

In one of these further steps, the safety system is switched to a failure mode A of the failure operation mode, with the motor vehicle being braked by means of a third brake system in the failure mode A. In the other of the two further steps, the safety system is switched to a failure mode B of the failure operation mode, with the motor vehicle being braked by the second brake system in the failure mode B.

Because of this doubly redundant method for operating the safety system, road traffic safety is increased, since in the event of a failure of the first brake system and a possible additional failure of the third brake system, the safety system may still be operated in order to brake the motor vehicle equipped with such a safety system.

It is noted that the method of the present aspect may be operated in embodiments using one or more of the embodiments that are discussed in the preceding with respect to the first exemplary aspect and in the following.

For this reason, the corresponding embodiments of the method are not described again here.

According to another exemplary aspect, a motor vehicle is provided with a safety system comprising at least one electric machine by means of which the motor vehicle may be driven, the safety system comprising a first brake system, a second brake system having the electric machine, and a third brake system, wherein the safety system may be switched from a normal operation mode, in which the motor vehicle may be braked by means of the first brake system, to a failure operation mode in which the motor vehicle may be braked by means of the second brake system.

For providing a a particularly high level of road safety and in some embodiments, the failure operation mode comprises a failure mode A, in which the motor vehicle may be braked using the third brake system, and a failure mode B, in which the motor vehicle may be braked using the second brake system.

In some embodiments the motor vehicle is designed to be at least highly automated. In this context, “highly automated” is to be understood as meaning that a driver of the motor vehicle is at least temporarily allowed to turn away from the corresponding driving tasks and the traffic situation. In other words, the highly automated vehicle (level 3) may handle certain driving tasks independently and without human intervention.

The motor vehicle is for example designed to be fully automated. Here, the driver is allowed to completely hand over a vehicle guidance so that the driver becomes a passenger of the motor vehicle. The fully automated vehicle (level 4) manages journeys on certain routes and/or in certain traffic situations completely independently. In this context, it is then also provided that the fully automated motor vehicle may and may drive completely without occupants.

In some embodiments, the motor vehicle is designed so that it may be driven autonomously. In the case of the autonomously drivable motor vehicle (level 5), no human driver is required to cope with any driving task, because the autonomous motor vehicle may cope with all traffic situations.

In some embodiments and in the event of a failure, a level 3 motor vehicle is switched from the normal operation mode directly to failure mode B, and that a level 4/5 motor vehicle in the event of a failure is first switched from the normal operation mode to the failure mode A and then from failure mode A to failure mode B.

It is noted that embodiments are possible that comprise combinations of the features of the described embodiments.

Reference will now be made to the drawings in which the various elements of embodiments will be given numerical designations and in which further embodiments will be discussed.

In the exemplary embodiments, the described components of the embodiments each represent individual features that are to be considered independent of one another, in the combination as shown or described, and in combinations other than shown or described. In addition, the described embodiments can also be supplemented by features of the invention other than those described.

Specific references to components, process steps, and other elements are not intended to be limiting. Further, it is understood that like parts bear the same or similar reference numerals when referring to alternate FIGS. It is further noted that the FIGS. are schematic and provided for guidance to the skilled reader and are not necessarily drawn to scale. Rather, the various drawing scales, aspect ratios, and numbers of components shown in the FIGS. may be purposely distorted to make certain features or relationships easier to understand.

In the following, a safety system 1, a motor vehicle 2 and a method for operating the safety system 1 are described together.

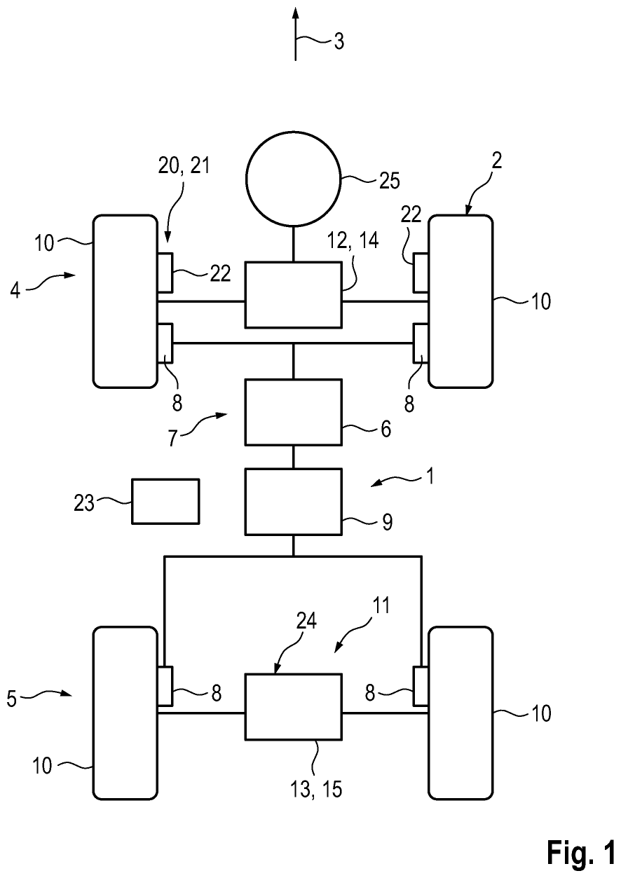

FIG. 1 shows a schematic view of the motor vehicle 2, which is designed to be drivable in a highly automated manner and comprises the safety system 1. This means that the safety system 1 is intentionally installed in the motor vehicle 2. For the further description, it is specified that the motor vehicle 2, which may in particular be configured as a passenger vehicle, in relation to a forward direction 3 comprises a first axle configured as a front axle 4 and a second axle configured as a rear axle 5 remote from it over a wheelbase. However, it is not excluded—especially if the motor vehicle is designed as a truck—that the motor vehicle 2 then has more than two axles.

In the present example, the motor vehicle 2, which is designed to be drivable in a highly automated manner, has an electronic brake booster 6. This electronic brake booster 6 is part of a first brake system 7, in particular an operational brake system of the motor vehicle 2. In a manual driving mode of the motor vehicle 2, the electronic brake booster 6 boosts a driver's foot force on a brake pedal (not shown) of the first brake system 7 in order to increase hydraulic brake pressure on wheel brakes 8 to brake the motor vehicle 2 as intended.

In addition to the electronic brake booster 6, the first brake system 7 has an ESC module or ESC unit (ESC: electronic stability control) or ESP unit 9 (ESP: electronic stability program). The ESP unit 9 is able to carry out brake interventions for each wheel. For this purpose, a hydraulic brake pressure is built up by means of a pump, which is then metered to the individual wheel brakes 8 by means of a valve control. This makes it possible to carry out both ABS control interventions (ABS: anti-lock braking system) and ESP control interventions. Correspondingly, in both cases, the vehicle 2 is driving straight ahead as well as driving turns, it is ensured that wheels 10 of the vehicle 2 do not block in an undesired manner. In addition, due to ESP unit 9 oversteering and/or understeering of motor vehicle 2 is prevented when driving turns.

The safety system 1 comprises the first brake system 7, that is to say both the electronic brake booster 6 and the ESP unit 9.

If the safety system 1, in particular the first brake system 7, is fully functional as intended, the safety system 1 is operated in the normal operation mode. If the safety system 1 is subject to a failure, it is switched from the normal operation mode to the failure operation mode. This is the case, for example, when the first brake system 7, for example due to damage to the same, completely or partially fails or has failed. Because then the motor vehicle 2 can no longer be braked using the full performance capacity of the first brake system.

The safety system 1 therefore comprises a second brake system 11. This means that the motor vehicle 2, provided that the safety system 1 is installed as intended, comprises the second brake system 11. Since the motor vehicle is designed to be electrically drivable, the motor vehicle 2 comprises at least one electric machine 12, in the present example the electrical machine 12 and a further electrical machine 13. It is provided that the electric machine 12 is arranged on the front axle 4 of the motor vehicle 2, so that the wheels 10 of the motor vehicle 2 arranged on the front axle 4 can be driven by the electric machine 12. It is also provided that the further electric machine 13 is arranged on the rear axle 5 of the motor vehicle 2, so that the wheels 10 of the motor vehicle 2 arranged on the rear axle 5 can be driven by means of the further electric machine 13. In order to drive or rather move the motor vehicle by means of the electric machines 12, 13, the electric machines 12, 13 are each operated as a motor. For this purpose, the electric machines 12, 13 are connected directly or indirectly to an electric energy storage device, for example an electric accumulator, so that electric energy is provided to the electric machines 12, 13 by means of the electric energy storage device, which in the respective electric machines 12, 13 is converted into a mechanical drive energy for the wheels 10.

Furthermore, it is not excluded that the motor vehicle 2 comprises further electric machines, for example that the motor vehicle 2 is equipped with electric machines on/in the wheel hubs, with electric machines close to the wheels, with electric machines in tandem arrangement (two motors on/in a common axle of the motor vehicle) or with a combination of these. The electric machines can be operated as a motor or generator.

For the case that the first brake system 7 is damaged and that as a result the motor vehicle 2 is only able to brake using the reduced performance compared to the normal operation mode or not at all, the safety system 1 comprises the second brake system 11, which comprises at least one of the electric machines 12, 13. In the present example, the second brake system 11 includes both the electric machine 12 and the electric machine 13. In this case, the respective electric machine 12, 13 represents a respective second brake actuator 14, 15 of the second brake system 11. To brake the electrically drivable motor vehicle 2 by means of the electric machines 12, 13 or by means of the second brake actuators 14, 15, the electric machines 12, 13 are operated as a generator. A braking force acting on the motor vehicle and counteracting a direction of movement of the motor vehicle 2 is therefore generated by means of the electric machines 12, 13 or by at least one of the electric machines 12 or 13. In the present example, a braking force acts against the forward direction of travel 3.

Here, the kinetic energy of the motor vehicle 2 is converted into electric energy, which is for example be provided to the electric energy storage device, for example is fed into it. If an energy absorption capacity of the electric energy storage device is fully used or insufficient for braking the vehicle as required, a further part of the electric energy can be made available to other electric consumers used in the motor vehicle 2. Furthermore, provision can be made to generate reactive power in one of the electric machines 12, 13 or in both electric machines 12, 13, so that the electric energy is converted into heat and radiated from the respective electric machine 12, 13. This heat can then be dissipated by means of an engine cooling system—if used in the motor vehicle 2. Alternatively or in addition, a braking resistor can be provided to which the electric energy generated during braking is fed, which also converts it into heat. The safety system 1 and/or the motor vehicle 2 equipped with the safety system 1 can be operated particularly efficiently if the electric energy generated when braking the motor vehicle 2 is used to charge a further energy storage device independent of the electric energy storage device. For example, the further energy storage device can have a kinetic storage element, for example a flywheel storage device, and/or a further electric storage element, for example a supercapacitor or an electric accumulator.

The failure operation mode of the safety system 1, which is used in the highly automated drivable motor vehicle 2, has a failure mode B in which the motor vehicle 2 can be braked or is braked by means of the second brake system 11 or by means of the electric machines 12, 13. For the highly automated drivable motor vehicle 2, this means that in the event of a complete or partial failure of the operating brake system or the first brake system 7 of the safety system 1, the safety system 1 goes directly into the failure mode B due to the switching of the safety system 1 from its normal operation mode into the failure operation mode. In other words, the failure operation mode comprises at least the failure mode B.

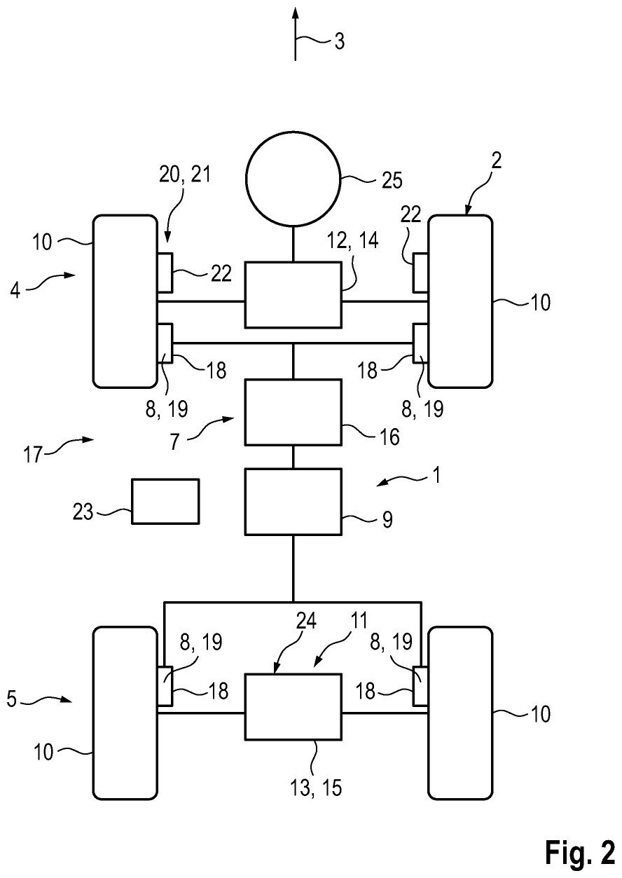

In connection with FIG. 2, in the following a failure mode A of the failure operation mode is described. For this purpose, FIG. 2 shows a schematic view of the motor vehicle 2, which can be driven in a fully automated manner and/or can be driven autonomously and comprises the safety system 1. In the fully automatically drivable and/or autonomously drivable motor vehicle 2 shown in FIG. 2, there is no mechanical connection between the possibly existing brake pedal and a hydraulic brake circuit, for example the operating brake or the first brake system 7. This is primarily due to the fact that a driver or passenger of the motor vehicle 2 must not trigger a braking of the motor vehicle 2 in an undesired or inadvertent manner. Because if the motor vehicle 2 is designed to be drivable in a fully automated manner, the driver of the motor vehicle 2 is then allowed to completely hand over a vehicle guidance, whereby the driver then becomes a passenger of the motor vehicle 2. If the motor vehicle 2 is designed to be autonomously drivable, the motor vehicle 2 takes over all driving tasks, so that occupants of the autonomously drivable motor vehicle 2 are only viewed as passengers and no longer as drivers. This means that in the motor vehicle 2 at least the operating brake system, that is to say the first brake system 7, is then designed as a so-called brake-by-wire brake system (brake-by-wire: braking by wire or signal cable). Therefore, the fully automatically drivable motor vehicle 2 or the autonomously drivable motor vehicle 2 has an integrated brake control system 16, which can be abbreviated to IBCS. The integrated brake control system 16 is part of the first brake system 7 of the fully automatically drivable or autonomously drivable motor vehicle 2 and detects a braking request by the driver in the manual driving mode of the vehicle 2 through sensor monitoring of the brake pedal (if available). This braking request, which is then present in form of an electric signal, is converted into hydraulic brake pressure with the help of a master cylinder. The hydraulic brake pressure is then metered directly or indirectly to the wheel brakes 8. Since the integrated brake control system 16 has its own valve control, both ABS control interventions and ESP control interventions can be carried out by means of the integrated brake control system 16.

The motor vehicle 2 shown in FIG. 2 also comprises the ESP unit 9, which has been described in connection with the motor vehicle 2 which is shown in FIG. 1 and is designed to be drivable in a highly automated manner. However, the ESP unit 9 of the fully automatically drivable or autonomously drivable motor vehicle 2 is part of a third brake system 17 of the safety system 1 or of the motor vehicle 2. The third brake system 17 is assigned to the failure mode A of the failure operation mode, which means that in the failure mode A of the failure operation mode of the safety system 1, the motor vehicle 2 can be braked or is braked by means of the third brake system 17.

At least one third brake actuator 18 of the third brake system 17 is formed by a first brake actuator 19 of the first brake system 7. In the present case, the respective third brake actuator 18 is formed by a wheel brake 8 of the first brake system 7. For the failure operation mode of the safety system 1, this means that the first brake actuators 19 or the wheel brakes 8, which are or can be controlled in the normal operation mode by means of the integrated brake control system 16, now can be controlled by means of the ESP unit 9 of the fully automated or autonomous motor vehicle 2, in particular in the failure mode A of the safety system 1. In other words, in the failure mode A of safety system 1, which represents a first fallback level of safety system 1, wheel brakes 8 are controlled by the ESP unit 9 instead of integrated brake control system 16. This means that it is provided that the safety system 1 is first switched from its normal operation mode into the failure mode A and is only switched from the failure mode A to the failure mode B. The failure mode B of the safety system 1 of the fully automatically drivable or autonomously drivable motor vehicle 2 shown in FIG. 2, which represents a second fallback level, runs analogously to the failure mode B of the highly automatically drivable motor vehicle 2 shown in FIG. 1.

The highly automated, fully automated and/or autonomously drivable motor vehicle 2 comprises a fourth brake system 20, by means of which in the failure operation mode of the safety system 1, i.e. in the case of the fully automated and/or autonomously driven motor vehicle 2 (level 4/5 motor vehicle) in the failure mode A and/or in the failure mode B, for example only in failure mode B, the motor vehicle 2 can be braked. In the case of motor vehicle 2 which can be driven in a highly automated manner (level 3 motor vehicle), the motor vehicle 2 can be braked in the failure mode B by means of the fourth brake system. In addition, the fourth brake system 20 is at least partially formed by an electric parking brake system 21, which in turn has fourth brake actuators 22. In the figures, the fourth brake actuators 22 are arranged on the front axle 4 of the motor vehicle 2. Alternatively, they can be located on the rear axle 5 of the motor vehicle 2 or the fourth brake system 20 comprises further fourth brake actuators 22 so that both the front axle 4 and the rear axle 5 of the motor vehicle 2 are equipped with fourth brake actuators. Since the fourth brake actuators 22 are designed to be controllable independently of one another, a quality of control can be increased in the failure mode, that is, in the failure mode A and/or in particular in the failure mode B, so that motor vehicle 2 can be braked particularly efficiently and safely. The electric parking brake system 21 can in particular have an electronic parking brake (EPB) or be formed by this. The electronic parking brake is a brake control system which is able to hold the motor vehicle 2 at a standstill by means of an electromechanical brake pressure either on both wheels 10 of the front axle 4 or on both wheels 10 of the rear axle 5.

In addition, it is provided in connection with the safety system 1 that a braking force applied to the front axle 4 and/or to the rear axle 5 is modulated as required by means of the fourth brake system 20 or by means of the electric parking brake system 21. This means that the motor vehicle 2, for example in the failure mode B, is already subject to braking due to the electric machines 12, 13 operated as a generator, so that the front axle 4 is braked by the electric machine 12 and/or the rear axle 5 is braked by the further electric machine 13. Thus, the first electric machine 12 or the second brake actuator 14 generates a basic braking moment on the front axle 4 and consequently on the wheels 10 of the motor vehicle 2 arranged on the front axle 4. The further electric machine 13 or the second brake actuator 15 also generates the basic braking moment on the rear axle 5 and consequently on the wheels 10 arranged on the rear axle 5. Here, the basic braking moment is selected in such a manner that a respective locking of the respective wheels 10 is avoided. However, this can mean that at least one of the wheels 10 of the corresponding axle of the motor vehicle 2 is not braked as efficiently as possible, since, for example, the left wheel of the front axle 4 is already threatening to lock, while the right wheel of the front axle 4 is still far from locking. This is related, for example, to the fact that a surface on which the motor vehicle 2 is braked provides the left wheel 10 of the front axle 4 with a lower coefficient of friction than the right wheel 10 of the front axle 4.

In order to decelerate the motor vehicle 2 particularly efficiently, i.e. with maximum braking force without locking wheels 10, in addition to the basic braking moment on the wheels 10 of the front axle 4 and/or on the wheels 10 of the rear axle 5, in particular individually for each wheel, an additional braking moment is applied by the fourth brake system 20 or by the electric parking brake system 21, the sum of the additional braking moment and of the basic braking moment then resulting in a respective total braking moment for each wheel. This means that the additional braking moment is then selected or dimensioned in such a way as required by means of the fourth brake system 20 or by means of the parking brake system 21 that ideally none of the wheels 10 of the motor vehicle 2 locks during the braking of the same. This means that through the interaction of the fourth brake system 20 and the second brake system 11 in the failure mode B, an ABS control is implemented. If the motor vehicle 2 comprises an electric machine 12 or 13 on only one of its axles and if the motor vehicle has the fourth brake system 20, for example in the form of the parking brake system 21, on the same axle, a two-channel ABS control is provided. If, for example, the motor vehicle 2 comprises the electric machine 12 on the front axle 4 and the further electric machine 13 on the rear axle 5, a three-channel ABS control is obtained. This already applies if the fourth brake system 20 has the two fourth brake actuators 22 only on the front axle 4 or on the rear axle 5. In addition, a four-channel ABS control is conceivable if a respective electric machine and/or a respective fourth brake actuator 22 is assigned to the respective wheel 10. Independently of the electric machine(s) of the motor vehicle 2, the four-channel ABS control results from the respective fourth brake actuator 22 assigned to the respective wheel 10.

The safety system 1 has a control device 23 by means of which, at least in the failure operation mode of the safety system 1, the performance capability of a drive unit 24 of the motor vehicle 2 can be determined based on the performance capability of the brake system 7, 11, 17, 20 assigned to the failure operation mode. Based on the fully automatically drivable motor vehicle 2 or autonomously drivable motor vehicle 2 shown in FIG. 2 it results for the failure mode A in which the motor vehicle 2 can be braked or is braked by the first brake system 1 that by means of a data set provided by the control device 23, it is communicated to the drive unit 24 that the safety system 1 has been switched to failure mode A, for example because the first brake system 7 is no longer available or is only available with reduced performance capability. On the basis of this, the performance capability of the drive unit 24 can be throttled, for example by the drive unit 24 providing only part of an acceleration capacity and/or only part of a maximum possible driving speed and/or part of a maximum possible steering angle etc. for use. This ensures that the motor vehicle 2 can be safely braked even when the safety system 1 is operating in the failure operation mode, in particular in the failure mode A, the third brake system 17 then being used to brake the motor vehicle 2.

Provision is made to adapt the performance capability of the drive unit not only to the performance capability of the currently working brake system 11, 17, 20 assigned to the respective failure mode A or B, but also to the predicted performance capability of the fallback level downstream or downstream of the current fallback level. Furthermore, the performance capability of the drive unit can be adapted or correspondingly throttled to the vehicle state and the environmental conditions that prevail in the surroundings of the motor vehicle 2. This is because the braking performance, in particular of the electric machine 12, 13, is variable, for example due to a variable SoC (state-of-charge—state of charge of the electrical accumulator) or a variable temperature of the electric accumulator. In addition, adverse ambient conditions, such as a low coefficient of friction due to wetness/ice, a gradient, etc., can influence maximum deceleration performance so that the braking performance of the downstream fallback level is no longer sufficient to adequately brake the vehicle from the degraded driving state. For example: the motor vehicle 2 travels at 100 km/h as part of the degraded continued journey. This means that the motor vehicle 2 is operated in the first fallback level or in the failure mode B. Suddenly the third brake system assigned to the failure mode B fails; a so-called second error occurs. The braking systems 11, 20 assigned to the second fallback level or to the failure mode A would only have to be reliably braked from a maximum driving speed of 80 km/h under the current environmental conditions and their corresponding performance. In order to prevent this, the control device 23 limits the maximum adjustable travel speed of the drive unit 24 to 80 km/h. This ensures that the vehicle is safely braked from the degraded onward journey even in the event of a second failure.

In an analogous manner, the performance capability of the drive unit 24 can be throttled when the safety system 1 is operating in the failure mode B. In particular, it is provided that the performance capability of the drive unit 24 in the failure mode B is further throttled or reduced compared to the performance capability of the drive unit 24 in the failure mode A.

In FIG. 1 and in FIG. 2 it can also be seen that the safety system 1 has a steering device 25 which, for example, has or is at least partially formed by an electrically drivable power steering (EPS: electronic power steering). It is particularly beneficial if the steering device 25 is formed by the electrically drivable power steering of the motor vehicle 2. The steering device 25 is designed or used in the motor vehicle 2 to support the braking of the motor vehicle 2 in the normal operation mode and in particular in the failure operation mode, that is to say in the failure mode A and/or in the failure mode B, of the safety system 1. Because, as already explained above, when the motor vehicle 2 is braked, at least one of the wheels 10 of the motor vehicle 2 may lock, as a result of which the motor vehicle 2 then assumes an unstable driving state. In order to counteract this unstable driving condition, for example skidding, or to leave it again as quickly as possible, counter-steering is suitable, for example, which can be or is carried out in the safety system 1 by the steering device 25.

Summarizing, the present teachings show how safety in road traffic can be increased by means of the safety system 1, by means of the method for operating the safety system 1 and by means of the motor vehicle 2. The fallback levels presented, that is to say the failure mode A and the failure mode B, include a use of at least one of the electric machines 12, 13 and/or at least one of the further electric machines. Furthermore, in the failure mode A and/or in the failure mode B, the fourth brake system 20, that is to say the parking brake system 21, and, in a further embodiment, the steering device 25 or the electrically driven power steering is used. The electric machines 12, 13, the parking brake system 21 and the electrically drivable power steering are installed as standard in today's electrically drivable motor vehicles, including the electrically drivable motor vehicle 2. This means that for the implementation of the safety system 1, provided that it is or is installed in the motor vehicle 2, no actuators are required via the actuators already used in the motor vehicle 2 in order to drive the highly automated motor vehicle 2 (level 3 motor vehicle, see FIG. 1) to be equipped with a fallback level or with the failure mode B. For the fully automated drivable or autonomously drivable motor vehicle 2 (level 4/5 motor vehicle, see FIG. 2), it is true that it does not need any actuators that are already present in the motor vehicle 2 in order to then control the motor vehicle 2 by means of the safety system 1 to give two fallback levels, that is, the first fallback level characterized by the failure mode B and the second fallback level characterized by the failure mode A.

Conventional fallback levels, which are nowadays provided in motor vehicles or motor vehicles that can be driven in a highly automated manner, are only able to carry out a single-channel ABS control (for example by means of an electronic brake booster) using justifiable economic and/or technical effort. On the other hand—as already mentioned above—with the highly automated drivable motor vehicle 2 by means of the safety system 1 in the failure mode B it is possible to carry out the two-channel ABS control if the motor vehicle 2 is only on the front axle 4 or only on the rear axle 5 one of the electric machines 12, 13. Furthermore, a three-channel ABS control by means of the safety system 1 of the motor vehicle 2 is made possible if the latter has a respective one of the electric machines 12, 13 on the front axle 4 and on the rear axle 5. Furthermore—as already described above—a four-channel ABS control is possible.

For motor vehicles 2, not only ABS control, but also ESP control, can be implemented by means of the safety system 1.

In the case of the safety system 1, it cannot be ruled out that the additional braking moment, which is modulated onto the basic braking moment when the motor vehicle 2 is braked by means of the electric machines 12, 13, is alternatively or additionally generated by means of a further ESP unit. Here it is conceivable that the further ESP module is lighter and less space-consuming, so that the further ESP module then has a lower performance capability than the ESP unit 9. This results in a particularly safe operation of the safety system 1, in particular the failure mode B, since a risk is minimized that the motor vehicle 2 is subjected to the unstable driving state during braking.

Numerical information (for example “first”, “second”, “third”, “fourth”, “A”, “B” etc.) do not constitute information of a hierarchy or a mandatory sequence or sequence.

### LIST OF REFERENCE NUMERALS

1 Security system
2 Motor vehicle
3 Forward direction of travel
4 Front axle
5 Rear axle
6 Electronic brake booster
7 First braking system
8 Wheel brake
9 ESP unit
10 Wheel
11 Second braking system
12 Electric machine
13 Electric machine
14 Second brake actuator
15 Second brake actuator
16 Integrated brake control system
17 Third braking system
18 Third brake actuator
19 First brake actuator
20 Fourth braking system
21 Electric parking brake system
22 Fourth brake actuator
23 Control device
24 Drive unit
25 Steering device

The invention has been described in the preceding using various exemplary embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The mere fact that certain measures are recited in mutually different dependent claims or embodiments does not indicate that a combination of these measures cannot be used to advantage. Any reference signs in the claims should not be construed as limiting the scope.

What is claimed is:

1. Safety system for an electrically drivable motor vehicle, with a first brake system and with a second brake system which comprises at least one electric machine designed for driving the motor vehicle, and with a third brake system; wherein
the safety system is switchable from a normal operation mode, in which the motor vehicle can be braked by the first brake system, into a failure operation mode, in which the motor vehicle can be braked by the second brake system; wherein
the failure operation mode comprises a failure mode A, in which the motor vehicle can be braked by the third brake system, and a failure mode B, in which the motor vehicle can be braked by the second brake system.

2. Security system of claim 1, wherein from the normal operation mode the safety system can first be switched into failure mode A and from failure operation mode A to failure mode B.

3. Security system of claim 1, wherein the third brake system comprises a third brake actuator which is formed by a first brake actuator of the first brake system.

4. Safety system of claim 1, further comprising a fourth brake system, using which the motor vehicle can be braked in the failure operation mode of the safety system and which is at least partially formed by an electric parking brake system.

5. Security system of claim 4, wherein the fourth brake system has at least two fourth brake actuators which can be controlled independently of one another.

6. Security system of claim 1, further comprising a control device which can be connected to a drive unit of the motor vehicle and which is configured to, at least in the failure operation mode of the safety system, determine the performance of the drive unit based on the performance of one of the brake systems and/or on environmental conditions prevailing in surroundings of the motor vehicle.

7. Security system of claim 1, further comprising a steering device configured to support braking of the motor vehicle in the failure operation mode of the safety system.

8. A method for operating a safety system for an electrically drivable motor vehicle with the following steps:
operating of the security system in a normal operation mode;
braking the motor vehicle by a first brake system;
switching the safety system from the normal operation mode to a failure operation mode;
braking the motor vehicle by a second brake system, wherein the motor vehicle is braked by an electric machine by means of which the motor vehicle can be driven; further comprising at least one of the following steps:
switching of the safety system into a failure mode A of failure operation mode, wherein in the failure mode A the motor vehicle is braked by means of a third brake system; and
switching the safety system into a failure mode B of the failure operation mode, wherein in failure mode B the motor vehicle is braked by the second brake system.

9. Highly automated motor vehicle with at least one electric machine by which the highly automated motor vehicle can be driven, and with a safety system designed according to claim 1, wherein from the normal operation mode, the safety system can be switched directly into the failure mode B, wherein the failure mode A is skipped.

10. Fully automated or autonomous motor vehicle, with at least one electric machine, by which the fully automated or autonomous motor vehicle can be driven, and with a safety system designed according to claim 1.

11. Security system of claim 2, wherein the third brake system comprises a third brake actuator which is formed by a first brake actuator of the first brake system.

12. Safety system of claim 2, further comprising a fourth brake system, using which the motor vehicle can be braked in the failure operation mode of the safety system and which is at least partially formed by an electric parking brake system.

13. Safety system of claim 3, further comprising a fourth brake system, using which the motor vehicle can be braked in the failure operation mode of the safety system and which is at least partially formed by an electric parking brake system.

14. Security system of claim 2, further comprising a control device which can be connected to a drive unit of the motor vehicle and which is configured to, at least in the failure operation mode of the safety system, determine the performance of the drive unit based on the performance of one of the brake systems and/or on environmental conditions prevailing in surroundings of the motor vehicle.

15. Security system of claim 3, further comprising a control device which can be connected to a drive unit of the motor vehicle and which is configured to, at least in the failure operation mode of the safety system, determine the performance of the drive unit based on the performance of one of the brake systems and/or on environmental conditions prevailing in surroundings of the motor vehicle.

16. Security system of claim 4, further comprising a control device which can be connected to a drive unit of the motor vehicle and which is configured to, at least in the failure operation mode of the safety system, determine the performance of the drive unit based on the performance of one of the brake systems and/or on environmental conditions prevailing in surroundings of the motor vehicle.

17. Security system of claim 5, further comprising a control device which can be connected to a drive unit of the motor vehicle and which is configured to, at least in the failure operation mode of the safety system, determine the performance of the drive unit based on the performance of one of the brake systems and/or on environmental conditions prevailing in surroundings of the motor vehicle.

18. Security system of claim 2, further comprising a steering device configured to support braking of the motor vehicle in the failure operation mode of the safety system.

19. Security system of claim 3, further comprising a steering device configured to support braking of the motor vehicle in the failure operation mode of the safety system.

20. Security system of claim 4, further comprising a steering device configured to support braking of the motor vehicle in the failure operation mode of the safety system.
